(19) United States
(12) Patent Application Publication
(10) Pub. No.: US 2010/0178183 A1
(43) Pub. Date: Jul. 15, 2010

(54) PUMP MOUNTING

(75) Inventors: Stephan Kaufmann, Gunzwil (CH); Daniel Kohli, Aarau (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: KNF FLODOS AG, Sursee (CH)

(21) Appl. No.: 12/601,963

(22) PCT Filed: Mar. 14, 2008
(86) PCT No.: PCT/EP2008/002046

§ 371 Date: Nov. 25, 2009

(30) Foreign Application Priority Data
Jun. 20, 2007 (DE) 10 2007 028 350.6

(51) Int. Cl. F04B 53/00; F16F 15/04

(52) U.S. Cl. 417/472; 248/638

(57) ABSTRACT

A device (1) is used to mount a pump on a base plate (4) in a structure-borne noise-insulated manner, with the pump including a pump flange (6, 6a, 6b) having at least one mounting hole (9, 19). A mounting screw (2) engages in the mounting hole (9, 19) and detachably mounts the pump flange (6, 6a, 6b) on the base plate (4). Elastic intermediate elements (7, 8) are provided between the upper side of the base plate (4) and the lower side of the pump flange and between the upper side of the pump flange and the screw head (11). A peripheral gap is present between the mounting screw (2) and the mounting hole wall (9, 19) of the pump flange (6, 6a, 6b).

### BACKGROUND

The invention relates to a device to mount a pump, particularly a diaphragm pump, on a base plate in a noise-insulated manner, with the pump comprising a flange having at least one fastening hole and a fastening screw engaging the at least one fastening hole, detachably fastening the pump flange at the base plate.

Usually, an electric motor serves as the drive of such pumps, with its rotary motion being converted into a linear lift motion via a crank drive or an eccentric. The drive may also occur via a linear drive, for example a solenoid drive. Oscillations develop regardless of the type of drive, transferred to the environment, for example, the base plate via the fastening screws engaging the pump housing. In this manner, disturbing noise can develop depending on the nature and resonance characteristics of the base plate.

From DE 38 34 362 A1 it is known to provide a rubber-elastic damper between the base plate and the connecting flange and between the connecting flange and the fastening screw head in order to dampen vibration. This certainly requires the assembly of the damper with increased attention to prevent to strong a compression of the damping material.

### SUMMARY

The object of the invention is to provide a device for fastening a pump on a base plate effectively reducing any transfer of noise from the pump to the base plate and allowing a simple fastening of the pump.

Such a device according to the invention is characterized in that an elastic intermediate element is provided between each of the upper side of the base plate and the lower side of the pump flange as well as between the upper side of the pump flange and the fastening screw and in a circumferential gap being provided between the fastening screw and the fastening hole wall.

This arrangement achieves the state that the pump flange has no direct contact to the screw and the base plate and thus cannot transfer noise. In order to achieve an effective noise insulation, the elastic elements comprise a minimum thickness depending on the elastic material. The circumferential gap between the fastening screw and the fastening hole wall ensures that even in case of lateral motions the flange is not in contact with the screw and thus no noise is transferred.

In order to secure the screw a safety means may be provided, for example an adhesive, to prevent that the screw loosens during operation.

In a preferred further development of the invention, a socket is arranged coaxially around each fastening screw, with a circumferential gap being provided between its outer wall and the fastening hole wall, and one face contacting the base plate and the other face forming a stop for the fastening screw. Any excessive tightening of the screw excessively compressing the elastic elements and potentially damaging them or forming noise bridges is therefore prevented.

The amount of noise insulation and dampening depends on the compression of the elastic elements. Therefore the elastic element between the upper side of the pump flange and the screw is dimensioned such that it projects from the upper edge of the socket prior to the assembly of the screw. Due to the length of the socket, the compression can be adjusted without exchanging the elastic elements, even retroactively. Therefore, the fastening torque no longer requires precise controlling during the assembly because a defined final position of the screw is predetermined by the fixed stop at the socket and thus the adherence to a predetermined compression is considerably facilitated.

Furthermore, the fixed stop at the socket prevents the screw from loosening due to the vibration during operation. In this way, any additional securing means can also be omitted.

If the fastening opening(s) in the pump flange is/are formed open at the edges it is also possible to fasten several pumps, with their fastening flanges being arranged adjacent to each other, for example two neighboring pumps, using the device according to the invention.

### BRIEF DESCRIPTION OF THE DRAWINGS

In the following, preferred embodiments of the invention are explained in greater detail using the drawings.

Shown are:

FIG. 1 a schematic cross-section of a noise-insulating fastening device,

FIG. 2 a schematic cross-section of another embodiment of the invention with two pump flanges arranged side-by-side, and

FIG. 3 a top view of the embodiment according to FIG. 2.

### DETAILED DESCRIPTION OF THE PREFERRED EMBODIMENTS

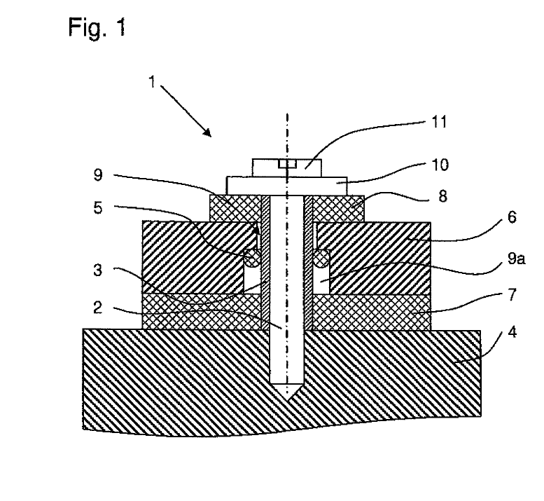

FIG. 1 shows the device for a noise-insulated fastening of a pump, marked 1 in its entirety. For reasons of simplification, only a portion of the pump flange 6 of the pump is shown. The pump flange 6 comprises a fastening hole as the fastening opening 9, with the screw 2 engaging it, screwed into the base plate 4. Instead of the screw, preferably a screwed-in threaded bolt can also be provided connected to the base plate 4, with the pump flange being secured via a nut.

A socket 3 is arranged coaxially in reference to the screw 2, which contacts the base plate with one face and with its other face contact the screw head 11. In the embodiment shown, a washer 10 is inserted between the screw head 11 and the elastic element 8 in order to enlarge the contact area.

Elastic elements 7, 8 are arranged between the upper side of the base plate 4 and the lower side of the pump flange and between the upper side of the pump flange and the screw head 11 or the washer 10, fixing the pump in the vertical direction and reducing the transfer of noise from the pump to the base plate 4.

Another elastic element 5 is arranged in the pump flange 6 between the socket 3 and the interior wall of the fastening hole 9, fixing the pump in the horizontal direction and preventing any direct contact of the socket 3 at the pump flange 6. The elastic element 5 in the form of an O-ring is inserted into an expansion 9a of the fastening hole 9 embodied as a gradual bore.

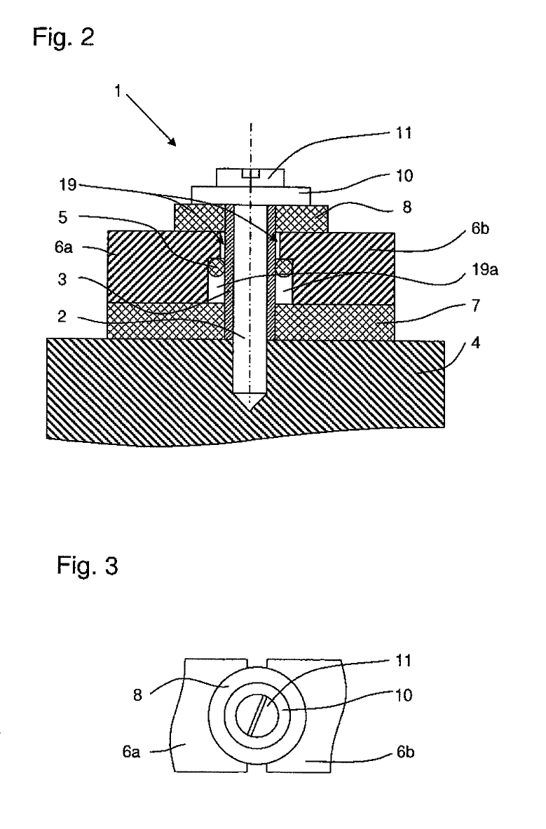

The embodiment according to FIG. 2 shows the fastening area of two pumps arranged side-by-side, with the pump flange 6a of one pump and the pump flange 6b of the other pump being fixed by a common fastening device 1. Instead of the fastening hole the pump flange 6a, 6b comprise recesses 19 with open edges, which may also comprise an expansion space 19a to accept another elastic element.

It is discernible from FIG. 3 that the two pumps are facing each other such that the pump flanges 6a, 6b are not in contact with each other, in order to prevent any unintended transfer of noise from one pump to the other.

1. A device for fastening at least one pump on a base plate (4) in a noise-insulating manner, with the pump comprising a pump flange (6, 6a, 6b) with at least one fastening opening (9, 19) and a fastening screw (2) engaging at least one fastening opening (9, 19), by which the pump flange (6, 6a, 6b) is detachably fastened to the base plate (4), characterized in that one elastic intermediate element (7, 8) each is provided between of the upper side of the base plate (4) and the lower side of the pump flange and between the upper side of the pump flange and the screw head (11), and a circumferential gap is provided between the fastening screw (2) and a fastening opening wall (9, 19) of the pump flange (6, 6a, 6b).

2. A device according to claim 1, characterized in that a socket (3) is provided coaxially in reference to the fastening screw (2) and passing through the fastening opening (9, 19) of the pump flange (6, 6a, 6b) and the elastic elements (7, 8), with a circumferential gap being provided between an outer wall of the socket and the fastening opening wall (9, 19) and with one face contacting the base plate (4) and an other face forming a stop for the screw head (11).

3. A device according to claim 2, characterized in that another elastic element (5), for example an O-ring, is provided between the socket (3) and an interior wall of the fastening opening (9, 19).

4. A device according to claim 3, characterized in that the fastening opening (9, 19) comprises an expansion space (9a, 19a) for accepting an elastic element (5).

5. A device according to one of claims 1 through 4, characterized in that the elastic elements (5, 7, 8) are made from rubber or a rubber-elastic material.

6. A device according to one of claims 1 through 4, characterized in that the elastic elements (5, 7,8) are made from a porous, foamed, and volume-compressible material, for example sponge rubber, EPDM-foam, or cellular rubber.

7. A device according to one of claims 1 through 6, characterized in that the fastening opening(s) (19) in the pump flange (6a, 6b) is/are embodied with open edges.
